(19) United States
(12) Patent Application Publication
(10) Pub. No.: US 2012/0141678 A1
(43) Pub. Date: Jun. 7, 2012

(54) Carbon Nanotube Ink

(75) Inventor: Jan Sumerel, San Jose, CA (US)

(73) Assignee: FUJIFILM DIMATIX, INC., Lebanon, NH (US)

(21) Appl. No.: 11/945,107

(22) Filed: Nov. 26, 2007

Related U.S. Application Data
(60) Provisional application No. 60/867,366, filed on Nov. 27, 2006.

(51) Int. Cl. B05D 1/26; C09D 11/02; B05D 5/00; B82Y 40/00; B82Y 30/00

(52) U.S. Cl. 427/256; 427/384; 106/31.13; 977/742; 977/892; 977/750; 977/752

(57) ABSTRACT

Carbon nanotube inkjet solutions and methods for jetting are described.

### CROSS-REFERENCE TO RELATED APPLICATIONS

This application claims priority to U.S. Provisional Application Ser. No. 60/867,366, filed on Nov. 27, 2006. The disclosure of the prior application is considered part of and is incorporated by reference in the disclosure of this application.

### TECHNICAL FIELD

This invention relates to depositing carbon nanoparticles.

### BACKGROUND

The field of carbon nanotubes (CNT) research has grown dramatically every year since 1991 when the structures of carbon nanotubes (CNTs) were described by electron microscopy. The great interest in carbon nanotubes is derived from their small nanometer length scale dimensions and remarkable chemical and physical properties. Because of these unique properties CNTs have many potential applications, but their applications are limited by methods of forming and applying CNTs. A variety of new synthesis methodologies have been developed in recent years. In addition, many characterization techniques have also facilitated the analysis of their structure at the atomic level, and as the direct result, the structural-function relationship of CNTs is becoming clear. There is data supporting the unique mechanical and physical properties of CNTs and a variety of real near-term applications have been demonstrated from these studies. These applications include, but are not limited to, scanning probe tips, field emitters for instrumentation and displays, nanoelectrodes for sensor applications, and efficient heat conductors.

Based on their microstructures, CNTs can be differentiated into two types: single-walled and multi-walled CNTs. A single-walled CNT (SWCNT) is a rolled-up tubular shell of graphene sheet, which is made up of benzene-type hexagonal rings of carbon atoms. A multi-walled CNT (MWCNT) is a rolled-up stack of graphene sheets in concentric cylinders, with interlayer thickness (0.34 nm) equal to that of the graphite. As the field of research for CNTs is developing, challenges in bringing CNT applications out of the laboratory remain in the manufacturing processing. Methods for large-scale use and highly precise deposition of a controlled amount of CNTs are desirable.

### SUMMARY

In some embodiments, ink jet solutions are described that have an organic component, a defoamer component and carbon nanotubes. The solution comprises less than about 0.008% of the defoamer component.

In some embodiments, a method of forming a carbon nanotube layer is described. An ink jet solution is jetted onto a substrate. The fluid is then evaporated from the solution to form the carbon nanotube layer.

Embodiments of the solutions and methods may include one or more of the following features. The solution may further comprise water, wherein the water comprises less than 30% of the solution. The organic component may be an alcohol, such as a diol, e.g., propanediol, or a C1 to a C6 alcohol. The solution may comprise between about 60-80% of the organic component. The solution may comprise less than about 0.005% of the defoamer component. The defoamer component may comprise nonionic compounds. The defoamer component may include one or more diol alcohols, such as 2, 4, 7, 9-tetramethyl-5-decyne-4,7-diol, and the defoamer component is a different compound than the organic component. The solution can further comprise a compound having a viscosity of at least 1000 cP at 293K. The solution may comprise less than 5% of the carbon nanotubes or less than 2% of the carbon nanotubes or between about 0.1%-5% of the carbon nanotubes. The solution can have a surface tension of between about 20-40 dynes/cm. The solution can have a viscosity of between about 1-5 centipoise at 17.7° C. The solution can be substantially free of polymers, binders, resins and adhesives. The solution can be jetted into droplets having an average diameter of about 40 microns. The solution can be jetted from a piezoelectric drop on demand inkjet printer.

Advantages of the solutions and processes described herein may include one or more of the following. Because with inkjet printing small quantities of CNTs are able to be expelled in each droplet, very small quantities of CNTs may be used Inkjet methods described herein are scalable, and thus are useful in manufacturing as well as laboratory settings. After a CNT film is formed, the substrate with the CNT film may be subjected to additional processes, including roll to roll manufacturing techniques or adding further printed thin films to an assembly including the CNTs. The CNT films may be used in field emission applications, low power X-ray tubes, and in sensors and electronics. Forming a layer of CNTs can achieve substrate strengthening, for example, a strong, light coating of CNTs can be added to a commercial product, such as an automobile exterior.

The CNT films can be applied to a wide range of substrates, such as polymers, semiconductors, or metals, or applied adjacent to other layers on a substrate, such as over organic layers or biomolecules. Jetting CNTs onto a substrate can allow for more flexible use of CNTs films, particularly in applications when other forms of CNT formation, such as chemical vapor deposition, are incompatible with the substrate or with other layers of the assembly on which the CNTs are applied. Using very low amounts of defoamer can allow for forming a CNT film that has a low level of contamination once the solution is dried.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an electron micrograph of a low density MWCNTs on a silicon wafer.

FIG. 2 is an electron dispersive spectroscopy of CNTs on a silicon wafer.

Like reference symbols in the various drawings indicate like elements.

### DETAILED DESCRIPTION

Ink jet printing can be used to form thin films of CNTs. Moreover, ink jet printing can apply the thin films very precisely, and thus can be used to form CNT structures, such as field emitters and nanoelectrodes for sensors and electronics.

Solutions for printing carbon nanotubes include an organic component and a wetting or a defoaming agent, as well as the carbon nanotubes. In addition, water can be a component of the solution. The organic component can be an alcohol, such as ethanol, propanol, for example, isopropanol, propanediol, pentanol or a combination thereof. In some embodiments, the organic component includes a C1 to C6 alcohol. CNTs are organic and hydrophobic and thus weak organic solvents for the solution can make up more than one third of the jetting solution. In embodiments, the organic component comprises at least 50% of the jetting solution, such as between about 60% and 80% of the solution, or more than about 60%, more than about 70% or more than about 80% of the solution.

The defoaming agent can be a nonionic compound, such as a diol, for example, 2, 4, 7, 9-tetramethyl-5-decyne-4,7-diol, linear alcohols or non-polar compounds. The defoaming agent can be used in small quantities, that is, quantities less than about 0.008% of the weight percent of the jetting solution, such as less than about 0.007%, 0.006%, 0.005% or 0.004% of the jetting solution. The defoaming agent can have low polarity. In addition to providing the advantage of reducing foam in the jetting solution, it is theorized that the defoamer compound wraps around the CNTs and when solution is centrifuged or sonicated, causing the defoamer/CNTs micelles to repel one another. Low concentrations of defoaming agent can keep contamination of the CNTs in the jetted layer low, while properly adjusting the surface tension of the solution. The low levels of defoaming agent can obviate any post processing necessary to remove contaminants.

The solution can also include a component that increases the overall viscosity of the solution. Such components may have a viscosity greater than 1000 cP at 293 K, such as glycerol. Glycerol can make up between about 2 and 40% of the solution, such as between about 5 and 30%, 7 and 25%, 10% and 20% or 12% and 18% of the solution, such as about 15% of the solution.

Optionally, if a pigmented layer of CNTs is desired, pigment can be added to the jetting solution. Without pigment, the final layer of CNTs may be transparent to a human observer. Water can make up the balance of the solution, if the solution is not entirely comprised of organics and CNTs. In some embodiments, the jetting solution has less than about 30% water, such as less than about 20% or less than about 10% water.

The surface tension of the jetting solution can be between about 10 and 50 dynes/cm at about 22° C., such as between about 15 and 40 dynes/cm, 15 and 35 dynes/cm or between about 28 and 33 dynes/cm. The viscosity can be between 1 and 10 centipoise at 17.7° C., such as between about 2 and 8 centipoise or about 3 centipoise.

The CNTs in the solution can be multi-walled or single-walled CNTs. The solution can include less than about 10%, such as less than about 5%, 4%, 3%, 2%, 1%, or 0.5% of the CNTs.

In some embodiments, the CNTs are bonded onto bases of DNA. Bonding the CNTs onto bases of the DNA can align the CNTs according to a helix or double helix configuration. Because of the size of the CNTs in comparison to the DNA bases, only select bases of the DNA may have CNTs bonded thereto. Bonding the CNTs to only one type of base, such as the pyrimidine or the purine bases, may allow for selectively locating the CNTs along the DNA.

The solutions described herein can be jetted using an inkjet printer, such as a DMP-2800 series printer available from FUJIFILM Dimatix, Inc., in Santa Clara, Calif.. The DMP-2800 is further described in “Fluid Deposition Device”, U.S. application Ser. No. 11/457,022, filed Jul. 12, 2006, which is incorporated herein by reference for all purposes. The DMP-2800 can print ink droplets having a size of about 10 picoliters and a diameter of about 40 microns with a drop on demand piezoelectric printhead having nozzles with an effective diameter of about 21.5 microns. The components of the jetting solution can be mixed together, such as by vortex mixing and sonication. The solution is then jetted onto a substrate. Once on the substrate, the non-CNT components of the jetting solution can be subsequently driven off, such as by heat or vacuum. A thin CNT film, such as a film having a thickness of less than 40 microns, e.g., less than about 30 microns, 20 microns, 10 microns or 5 microns can be formed.

Optionally, after deposition of the CNTs, a surface bonding process can be performed. The CNTs can be actively manipulated, such as by manipulating the jetting solution or by a self assembly process. For example, a method of orienting the CNTs may include changing the surface energy of the substrate. Alternatively, a patterned hydrophilic or hydrophobic substrate surface can align the CNTs by wicking the jetting solution. Alignment can occur prior to driving off the fluid from the jetting solution.

After a CNT film is formed, the substrate with the CNT film can be subjected to additional processes, including roll to roll manufacturing techniques or adding further printed thin films to an assembly including the CNTs. Non-contact deposition of the CNTs, that is, printing, is an additive process that can be combined with other manufacturing techniques, such as lithography, chemical etching and laser ablation.

Because with inkjet printing small quantities of CNTs are able to be expelled in each droplet, very small quantities of CNTs may be used Inkjet methods described herein are scalable, and thus are useful in manufacturing as well as laboratory settings. The CNT films may be used in field emission applications, low power X-ray tubes, and in sensors and electronics. Forming a layer of CNTs can achieve substrate strengthening, for example, a strong, light coating of CNTs can be added to a commercial product, such as an automobile exterior. The CNT films can be applied to a wide range of substrates, such as polymers, semiconductors, or metals, or applied adjacent to other layers on a substrate, such as over organic layers or biomolecules. Jetting CNTs onto a substrate can allow for more flexible use of CNT films, particularly in applications when other forms of CNT formation, such as chemical vapor deposition, are incompatible with the substrate or with other layers of the assembly on which the CNTs are applied.

### Example

Jetting fluid was formed using MWCNTs having lengths between about 0.5 and 2 microns and obtained from Aldrich Chemicals. An emulsion was made using 1% of the MWCNTs, 0.009% Surfynol 104PA from Air Products, Inc., 69% propanediol from Sigma Aldrich and water. The emulsion was mixed for two hours at room temperature by intermittent vortex mixing at high speed. The emulsion had a surface tension of 28.8 dynes/cm and a viscosity at 17.7° C. was 3 centipoise.

The emulsion was jetted onto a silicon wafer using a DMP-2800 from FUJIFILM Dimatix, Inc. After jetting, the silicon wafer was placed in a vacuum to remove the propanediol.

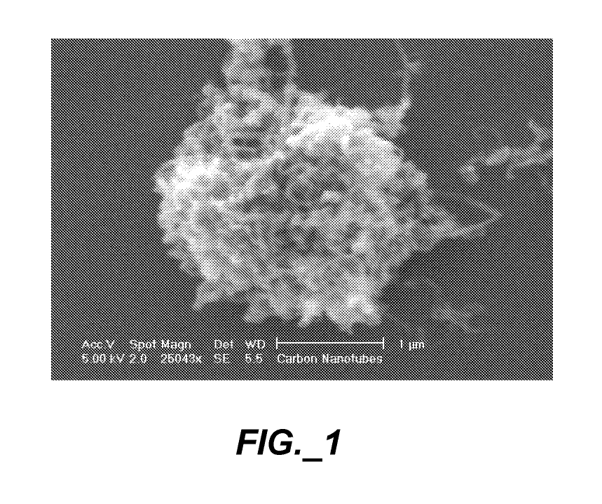

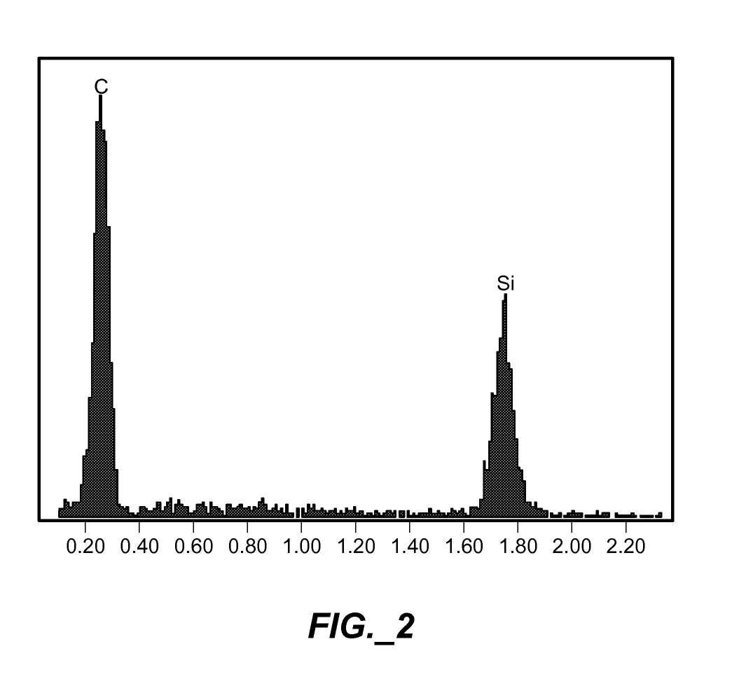

Referring to FIG. 1, an electron micrograph shows the low density MWCNTs on the surface of the silicon wafer. Referring to FIG. 2, an electron dispersive spectroscopy gives relatively pure carbon and a relatively pure silicon signature for the CNTs deposited on the silicon wafer. It is believed that the low concentration of defoaming agent allows for the relatively pure carbon and silicon signatures.

A number of embodiments of the invention have been described. Nevertheless, it will be understood that various modifications may be made without departing from the spirit and scope of the invention. Accordingly, other embodiments are within the scope of the following claims.

What is claimed is:

1. A jetting solution, comprising:
an organic component;
a defoamer component, wherein the solution comprises less than about 0.008% of the defoamer component; and
carbon nanotubes.

2. The solution of claim 1, further comprising water, wherein the water comprises less than 30% of the solution.

3. The solution of claim 1, wherein the organic component is an alcohol.

4. The solution of claim 3, wherein the alcohol is a diol alcohol.

5. The solution of claim 3, wherein the alcohol is propanediol.

6. The solution of claim 3, wherein the alcohol is a C1 to a C6 alcohol.

7. The solution of claim 1, wherein the solution comprises less than about 0.005% of the defoamer component.

8. The solution of claim 1, wherein the defoamer component comprises nonionic compounds.

9. The solution of claim 1, wherein the defoamer component includes one or more diol alcohols and the defoamer component is a different compound than the organic component.

10. The solution of claim 1, wherein the defoamer component includes 2, 4, 7, 9-tetramethyl-5-decyne-4,7-diol.

11. The solution of claim 1, wherein the solution comprises between about 60-80% of the organic component.

12. The solution of claim 1, further comprising a compound having a viscosity of at least 1000 cP at 293 K.

13. The solution of claim 1, wherein the solution comprises less than 5% of the carbon nanotubes.

14. The solution of claim 13, wherein the solution comprises less than about 2% of the carbon nanotubes.

15. The solution of claim 1, wherein the solution comprises:
between about 60 and 80% of the organic solvent, wherein the organic solvent includes propanediol;
between about 0.001 and 0.008% of the defoamer component, wherein the defoamer component includes 2-propanol and 2, 4, 7, 9-tetramethyl-5-decyne-4,7-diol; and
between about 0.1%-5% of the carbon nanotubes.

16. The solution of claim 1, wherein the solution has a surface tension of between about 20-40 dynes/cm.

17. The solution of claim 1, wherein the solution has a viscosity of between about 1-5 centipoise at 17.7° C.

18. The solution of claim 1, wherein the solution is substantially free of polymers, binders, resins and adhesives.

19. A method of forming a carbon nanotube layer, comprising:
jetting the solution of claim 1 onto a substrate; and
evaporating fluid from the solution to form the carbon nanotube layer.

20. The method of claim 19, wherein jetting the solution comprises jetting droplets having an average diameter of about 40 microns.

21. The method of claim 19, wherein jetting the solution comprises ejecting droplets from a piezoelectric drop on demand inkjet printer.
